(19) United States
(12) Patent Application Publication
(10) Pub. No.: US 2014/0180801 A1
(43) Pub. Date: Jun. 26, 2014

(54) SYSTEMS AND METHODS FOR DYNAMICALLY PLACING ADVERTISEMENTS WITHIN DIGITAL CONTENT

(71) Applicant: Ramsey Homsany, San Francisco, CA (US)

(72) Inventor: Ramsey Homsany, San Francisco, CA (US)

(21) Appl. No.: 13/723,037

(22) Filed: Dec. 20, 2012

(51) Int. Cl. G06Q 30/02

(52) U.S. Cl. CPC G06Q 30/0241
USPC 705/14.49; 705/14.4

(57) ABSTRACT

A system for dynamically inserting advertisements into digital content is disclosed. In various embodiments, the system may be configured to receive a request to access digital content. In response to the request, the system may be configured to dynamically adjust the formatting of the digital content to create space in which the system can place an advertisement. Adjusting the formatting of the digital content may include moving text and/or images within the digital content to create the advertising space. The system may determine how to adjust the formatting of the digital content based on the type of device with which the digital content is being accessed. The system may also overlay partially transparent advertisements onto digital content.

### BACKGROUND

Advertisers desire new and more efficient ways to present advertising content to potential customers. Accordingly, there is a need for improved systems and methods for advertising to potential customers.

### SUMMARY

A computer-implemented method dynamically inserting advertisements into digital content may include receiving a request to view digital content. The method may further include, in response to receiving the request, adjusting the formatting of the requested digital content to create an advertising space. In particular embodiments, the method may also include inserting an advertisement into the advertising space and communicating the requested digital content along with the inserted advertisement to a user.

A computer-readable medium, according to various embodiments, stores computer-executable instructions for: (1) receiving, from a first user of a synced content management system, a request to access particular digital image content; (2) in response to receiving the request, selecting a digital advertisement to overlay over the particular digital image content; (3) modifying the digital image content so that the digital advertisement is overlaid over the digital image content; and (4) communicating the requested digital content with the modified advertisement to the first user.

### BRIEF DESCRIPTION OF THE DRAWINGS

Various embodiments of a computer system for dynamically placing advertisements within digital content are described below. In the course of this description, reference will be made to the accompanying drawings, which are not necessarily drawn to scale, and wherein:

FIG. 1 shows a block diagram of a content management system in accordance with an embodiment of the present system;

FIG. 2 shows a schematic diagram of a computer, such as the content management server of FIG. 1;

FIG. 3 shows a flow chart that generally illustrates various steps executed by a dynamic advertising module that, for example, may be executed by the content management server of FIG. 1; and

FIGS. 4-5 show screen shots of an exemplary dynamic advertisement insertion system.

### DETAILED DESCRIPTION

Various embodiments now will be described more fully hereinafter with reference to the accompanying drawings. It should be understood that the invention may be embodied in many different forms and should not be construed as limited to the embodiments set forth herein. Like numbers refer to like elements throughout.

### Overview

A computer system according to particular embodiments may provide advertisements within digital content stored, for example: (1) within a cloud-based content management system such as a synched content management system; (2) on a local computer. Content stored within a cloud-based content management system may be stored on central servers, so that a user may access the files at any time, from any device with Internet access.

Additionally, in various embodiments, the system may be configured to allow a user to share content by sending a link to particular content stored on the system. In various embodiments, a user accessing the link may only be granted view access to the file. In other embodiments, the user may have permission to view, read, write, edit, and/or delete the accessed file.

Using this aspect of the system, the system may be configured to allow users to easily share digital content with other users. For example, a user may write a short story using a word processor on a computer. The user may then store the file containing the short story in the system (which may be a cloud-based content management system, such as the Dropbox™ content management service offered by Dropbox, Inc. of San Francisco, Calif.). In this example, the user may then send a link to other users (e.g., friends, individuals who have expressed an interest in the user's written work, etc.) granting them permission to view the file (e.g., read the story). In other words, the user can conveniently digitally share the short story with select people through a link rather than sending a digital copy through email, or printing and distributing the story.

The system may also be configured to dynamically insert advertisements into digital content, such as digital content that may be shared or otherwise accessed via a shared document management system. The system may be configured to manipulate the digital content to create space in which to place advertisements. In various embodiments, the system may manipulate digital content by, for example, adjusting the position and/or size of text, images, audio, video or other content within a particular piece of digital content, or by performing any other adjustment suitable for creating space in which to place an advertisement. In particular embodiments, the system may be configured to overlay partially transparent advertisements over portions of digital content such as images or documents. In various embodiments, the system may be configured to insert different advertisements in different locations within the digital content based on factors such as the device with which the digital content is accessed, the user that accesses the digital content, whether the digital content is shared digital content, etc.

The insertion of advertisements within digital content may be desirable in the context of digital content shared over a content management system as described above, which may, for example, be viewed by a large number of users of the content management system. In particular embodiments, the system is adapted to track the number of times that a particular piece of digital content including advertisements is accessed and compensate the owner of the digital content for the commercial use of the content.

### Exemplary Technical Platforms

As will be appreciated by one skilled in the relevant field, the present invention may be, for example, embodied as a computer system, a method, or a computer program product. Accordingly, various embodiments may take the form of an entirely hardware embodiment, an entirely software embodiment, or an embodiment combining software and hardware aspects. Furthermore, particular embodiments may take the form of a computer program product stored on a computer-readable storage medium having computer-readable instructions (e.g., software) embodied in the storage medium. Various embodiments may take the form of web-implemented computer software. Any suitable computer-readable storage medium may be utilized including, for example, hard disks, compact disks, DVDs, optical storage devices, and/or magnetic storage devices.

Various embodiments are described below with reference to block diagrams and flowchart illustrations of methods, apparatuses (e.g., systems) and computer program products. It should be understood that each element of the block diagrams and flowchart illustrations, and combinations of elements in the block diagrams and flowchart illustrations, respectively, can be implemented by a computer executing computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

These computer program instructions may also be stored in a computer-readable memory that can direct a computer or other programmable data processing apparatus to function in a particular manner such that the instructions stored in the computer-readable memory produce an article of manufacture that is configured for implementing the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Accordingly, block diagram elements and flowchart illustrations support combinations of mechanisms for performing the specified functions, combinations of steps for performing the specified functions, and program instructions for performing the specified functions. It should also be understood that each block diagram element and flowchart illustration, and combinations of block diagram elements and flowchart illustrations, can be implemented by special purpose hardware-based computer systems that perform the specified functions or steps, or combinations of special purpose hardware and other hardware executing appropriate computer instructions.

### Exemplary System Architecture

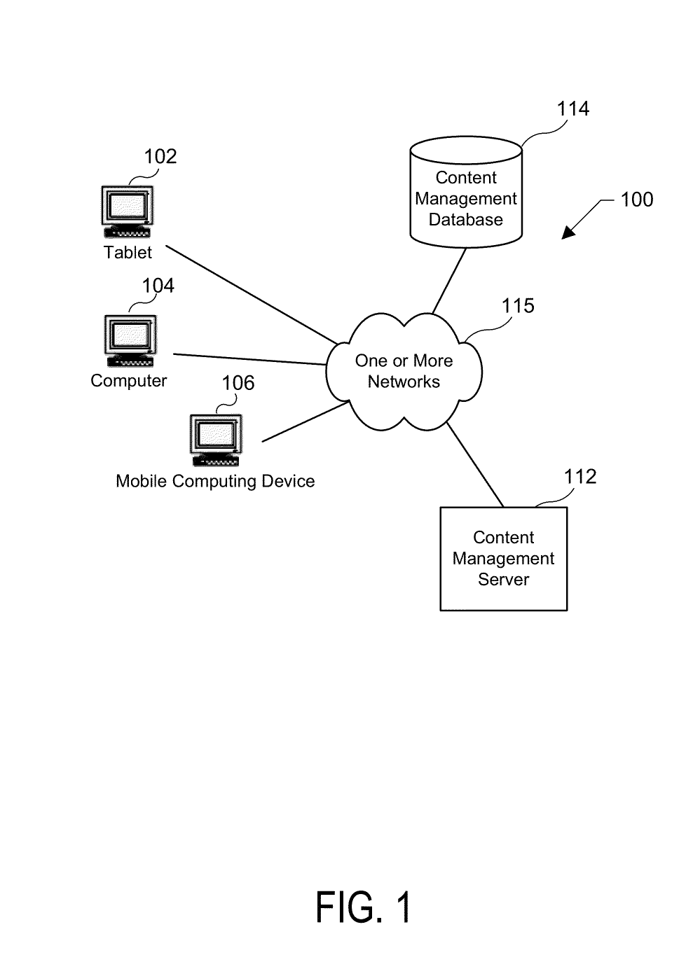

FIG. 1 shows a block diagram of content management system 100 according to a particular embodiment. As may be understood from this figure, content management system 100 may include remote computing devices such as tablet computer 102, desktop or laptop computer 104, or mobile computing device 106 (e.g., a handheld device, a cellular phone, a smart phone, or any other device capable of transferring files over network 110) that are in communication with content management server 112 (which, for example, may be used to execute one or more modules as described below) and content management database 114 (which, for example, may be used to store the files on the content management system) via one or more networks 110. Network 110 between content management server 112 and remote computing devices 102, 104, and 106 may be, for example, implemented via one or more wired or wireless networks such as LANs, WANs, a cellular network, a Wi-Fi network, or via the Internet. For purposes of ease of explanation and clarity, no specific network is shown in FIG. 1. Network 110 may include any of a variety of types of wired or wireless communication networks, such as the Internet. Mobile device 106 may transmit data wirelessly over cellular network by communicating with a cellular tower

The users of each of tablet computer 102, desktop computer 104, and mobile device 106 may have file storage accounts on content management server 112. In various embodiments, content management server 112 may include one or more servers that are located in close physical proximity, or some servers may be locally together and others remote. In either case, all devices, wherever located, function as a system.

Content management server 112 facilitates file access and file storage between content management server 112 and remote client computing devices, such as desktop computer 104, or mobile computing device 106, which may be, for example, a handheld device or tablet computer 102. Content management server 112 receives files from and sends files to remote computing devices 102, 104, 106 consistent with the user's preferences for sharing files. Content management server 112 may act as the counterpart to a client-side file storage service client application user interface that allows a user to manipulate files directly stored on content management server 112. In some embodiments, software operating on remote client computing devices 102, 104, 106 integrates network-stored files with the client's local file system to enable a user to manipulate network-stored files through the same user interface (UI) used to manipulate files on the local file system, e.g., via a file explorer, file finder or browser application. As an alternative or supplement to the client-side file-explorer interface, content management server 112 may provide a web interface for remote computing devices 102, 104 106 to access (e.g. via a web browser) and allow a user to manipulate files stored on content management server 112. In this way, the user can directly manipulate files stored on content management server 112.

In various embodiments, content management database 114 stores files such as those uploaded using remote computing devices 102, 104, 106. It should be understood that, in various embodiments, content management database 114 may include multiple data stores—some local to, and some remote from, content management server 112.

Content management database 114 maintains, for each user, information identifying the user, information describing the user's file directory, etc. in a file journal that is maintained for each user. In some embodiments, the file journal is maintained on content management server 112. This file journal may be updated periodically using information obtained directly from content management server 112 and/or from information obtained from one or more remote client computing devices 102, 104, 106. In this way, the server-stored file journal on content management server 112 (hereinafter the “server-side file journal”) is updated when a file is changed on the server or on the local client. Content management server 112 then communicates with one or more remote computing devices 102, 104, 106 to assure that any relevant changes are reflected locally. For example, if a user makes a change to a particular file on a first client device, the change may be reflected in the server-side file journal. The system then uses the server-side file journal to propagate the changes to the file to all client devices associated with the file. Such techniques may be implemented, for example, within the context of a synchronized content management system such as the Dropbox™ Service of Dropbox, Inc. of San Francisco, Calif.

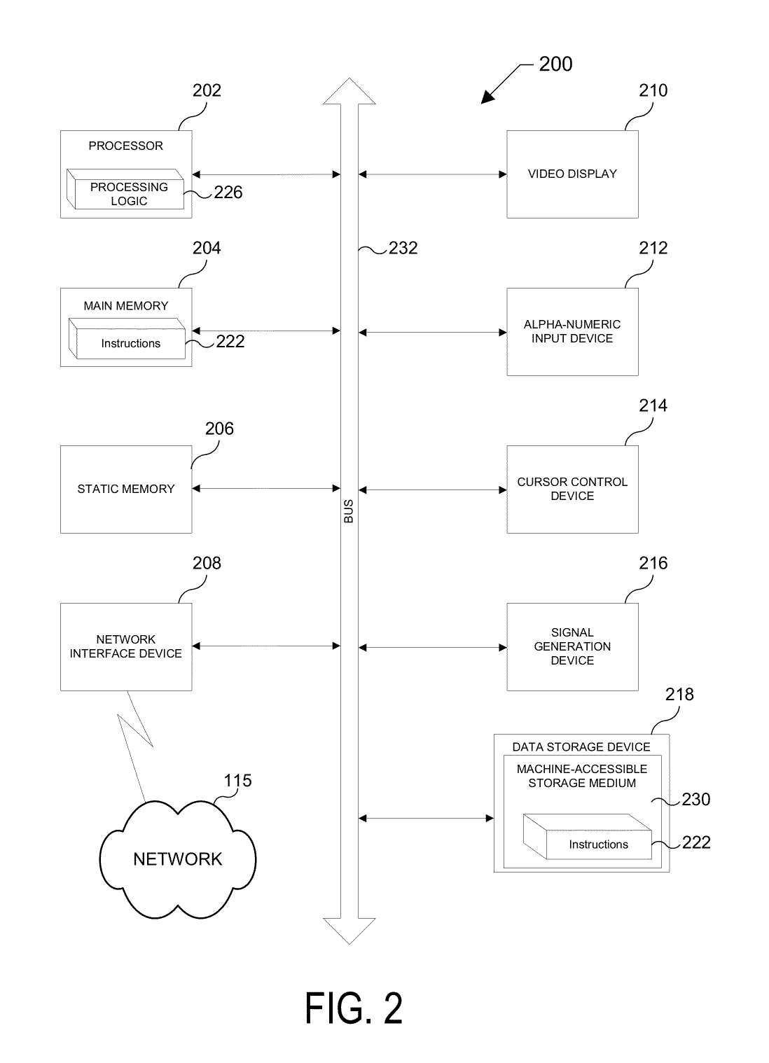

FIG. 2 illustrates a diagrammatic representation of computer 200 that can be used within content management system 100, for example, as client computer, or as content management server 112 (FIG. 1). For purposes of this disclosure, reference to a server or processor shall be interpreted to include either a single server, a single processor, or multiple servers, or multiple processors.

In particular embodiments, computer 200 may be connected (e.g., networked) to other computers by a LAN, WAN, an intranet, an extranet, and/or the Internet. Computer 200 may operate in the capacity of a server or a client computer in a client-server network environment, or as a peer computer in a peer-to-peer (or distributed) network environment. Computer 200 may be personal computer (PC), tablet PC, mobile device, a web appliance, a server, a network router, a switch or bridge, or any computer capable of executing a set of instructions (sequential or otherwise) that specify actions to be taken by that computer. Further, while only a single computer is illustrated, the term “computer” may also include any collection of computers that individually or jointly execute a set (or multiple sets) of instructions to perform any one or more of the methodologies discussed herein.

Exemplary computer 200 includes processor 202, main memory 204 (e.g., read-only memory (ROM), flash memory, dynamic random access memory (DRAM) such as synchronous DRAM (SDRAM) or Rambus DRAM (RDRAM), etc.), static memory 206 (e.g., flash memory, static random access memory (SRAM), etc.), and data storage device 218, which communicate with each other via bus 232.

Processor 202 represents one or more general-purpose processing devices such as a microprocessor, a central processing unit, or the like. More particularly, the processing device may be a complex instruction set computing (CISC) microprocessor, reduced instruction set computing (RISC) microprocessor, very long instruction word (VLIW) microprocessor, or processor implementing other instruction sets, or processors implementing a combination of instruction sets. Processor 202 may also be one or more special-purpose processing devices such as an application specific integrated circuit (ASIC), a field programmable gate array (FPGA), a digital signal processor (DSP), a network processor, or the like. Processor 202 may be configured to execute processing logic 226 for performing various operations and steps discussed herein.

Computer 200 may further include a network interface device 208. Computer 200 also may include video display 210 (e.g., a liquid crystal display (LCD) or a cathode ray tube (CRT)), alphanumeric input device 212 (e.g., a keyboard), cursor control device 214 (e.g., a mouse), and signal generation device 216 (e.g., a speaker).

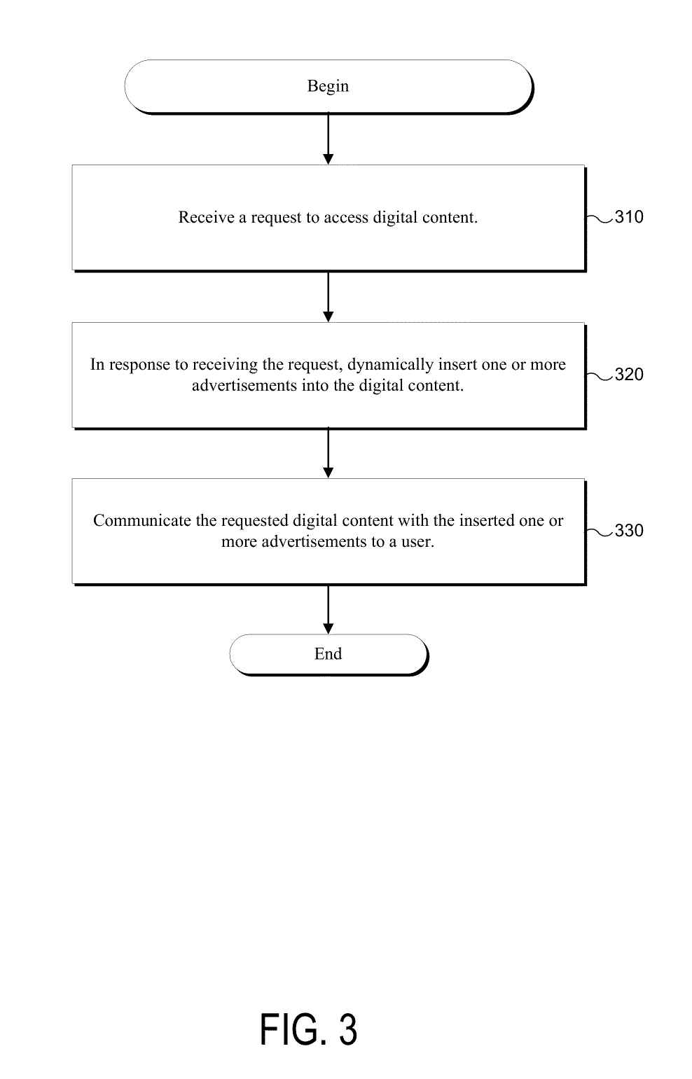

Data storage device 218 may include machine accessible storage medium 230 (also known as a non-transitory computer-accessible storage medium, a non-transitory computer-readable storage medium, or a non-transitory computer-readable medium) on which is stored one or more sets of instructions (e.g., a dynamic advertising module, which is configured to carry out the steps illustrated in FIG. 3) embodying any one or more of the methodologies or functions described herein. A dynamic advertising module may also reside, completely or at least partially, within main memory 204 and/or within processing device 202 during execution thereof by computer 200, main memory 204, and processing device 202 also constituting computer-accessible storage media. Instructions 222 (e.g., dynamic advertising module) may further be transmitted or received over network 220 via network interface device 208.

While machine-accessible storage medium 230 is shown in an exemplary embodiment to be a single medium, the term “machine-accessible storage medium” should be understood to include a single medium or multiple media (e.g., a centralized or distributed database, and/or associated caches and servers) that store the one or more sets of instructions. The term “machine-accessible storage medium” shall also be understood to include any medium that is capable of storing, encoding, or carrying a set of instructions for execution by the computer and that cause the computer to perform any one or more of the methodologies of the present invention. The term “computer-accessible storage medium” shall accordingly be understood to include, but not be limited to, solid-state memories, optical and magnetic media.

### Exemplary System Operation

Mobile device 106 and content management server 112 may alone, or in combination, perform the method steps of FIG. 3. It should be understood by reference to this disclosure that these methods describe exemplary embodiments of the method steps carried out by the present system, and that other exemplary embodiments may be created by adding other steps, by removing one or more of the method steps shown in FIG. 3, or by performing the method steps in an alternate order.

FIG. 3 shows processing functions performed by a computer system executing an exemplary dynamic advertising module, in accordance with various embodiments, that dynamically inserts advertisements into digital content. Beginning at Step 310, the system receives a request to access digital content. In various embodiments, the digital content may include any digital content such as text documents, PDF files, audio files, spreadsheets, images, video files, etc. In particular embodiments, the system may receive the request from a user of a synced cloud-based content management system such as the system described above, or from any other user with access to the digital content.

The system continues, at Step 320, by, in response to receiving the request at Step 310, dynamically inserting one or more advertisements into the digital content. In various embodiments, the system may be configured to dynamically insert advertisements into the digital content in any of a variety of ways. For example, in particular embodiments, the system may be configured to overlay advertisements onto the requested digital content (e.g., by placing one or more partially transparent advertisements over the digital content in a particular document).

In another example, the system may be configured to dynamically adjust the digital content to create space, within the digital content, in which to place the one or more advertisements. For example, in various embodiments, the system may adjust one or more frames of a video to create space for advertising within the video. In various embodiments, the system may use this technique, for example, to include advertisements across the top, bottom, or side portion of the video. The system may also be configured to add advertisements at the beginning or end of a video.

In the case of a text document, the system may be configured to adjust the spacing and/or configuration of the text within the document to create space for an advertisement. The system may, for example, format the document's text into columns and/or push text onto another page of the document in order to create advertising space. The system may also adjust the font size of text or images in the document to create advertising space. In other embodiments, the system may be configured to utilize any suitable space-creation technique that allows the system to place one or more advertisements within the document (or other digital file) while maintaining at least the basic content of the original document.

In the case of a photo, the system may be configured to adjust the positioning of the image within the photo to create space for an advertisement within the photo, and then selectively insert one or more advertisements into the advertising space. As an alternative, the system may overlay an advertisement onto the photo (e.g., so as to make the photo appear as if it originally included the advertisement). As a particular example, the system may modify a photo of an individual wearing a plain gray T-shirt so that that an advertisement (e.g., a corporate logo) appears on the T-shirt. This essentially allows for advertisement placements within personal photos. In particular embodiments, an owner of the photo may be compensated for advertising revenue generated by the system's placement of advertisements within their photos.

In various embodiments, the system may be configured to dynamically insert advertisements based on the type of device that a user is to use to access the requested digital content. For example, in a particular embodiment, the system may be configured to dynamically insert advertisements of a particular type or in a particular manner depending on the type of device with which the digital content is to be accessed. For example, the system may be configured to place an advertisement in a text document to be viewed on a desktop computer within the body of the text document, in a space between two paragraphs at the top of the first page of the text document. If the same text document is to be viewed on a mobile device (e.g., a smart phone, tablet, etc.), the system may dynamically move the content of the text document down within the document and then place the advertisement in the vacated space created near the top of the document. As part of the above concept, the system may be configured to automatically determine the type of device that a particular document is to be displayed on, and then determine how to position an advertisement within digital content based on the determined type of device.

In various embodiments, the system may be configured to place (e.g., select and/or position) advertisements based on information associated with the user accessing particular digital content in which the advertisements may be placed. In the case of shared digital content such as content that is stored in a shared folder within an on-line content management system, the system may be configured to place advertisements based on information associated with users (e.g., a combination of users) having access to (e.g., sharing) the shared digital content. Information associated with the users may include, for example, information about the users' collective internet browsing history, collective on-line purchase history, the content of the users' accounts within the content management system (e.g., the number and types of files that the users store within their respective accounts, and/or the content of the files—as determined, for example, by the content itself or metadata associated with the content) and/or any other suitable information for use in directing advertisements.

In particular embodiments, the system may be configured to place (e.g., select and/or position) advertisements based on the content or characteristics of the digital content. This may include, for example, the text of a word document, images in an image document, or any other relevant content within the digital content. As a particular example, if a user is accessing a stored copy of the boarding pass for an upcoming flight to Barcelona, the system may direct advertisements to the user based at least in part on travel, and particularly based on travel to Barcelona. For example, the system may direct advertisements or provide offers for Barcelona car rentals, hotels, tourist attractions or any other related advertisement.

In particular embodiments, the system may be configured to determine digital content that is related to the digital content which the user has requested to access. Related digital content may include, for example, digital content that is frequently shared along with the requested digital content (e.g., by other users having shared accessed to the digital content). In various embodiments, the system may be configured to determine that digital content is related to other digital content based on any other suitable factor. The system may then be configured to place one or more advertisements in the requested digital content based on the content of the digital content that the system has determined is related to the requested digital content.

In particular embodiments, the system may be configured to dynamically insert different advertisements each time a particular piece of digital content is accessed (e.g., each time a particular file is opened or otherwise accessed by any user). Also, in certain embodiments, the system may be configured to alter the dynamic placement of one or more advertisements each time a particular piece of digital content is accessed. For example, during a first access of a particular document file by a user, the system may dynamically insert an advertisement between two columns of text within the document near the top of the document's first page. Upon a subsequent access of the document by the user, the system may dynamically insert an advertisement (e.g., the same or different advertisement) in a space that the system creates near a bottom portion of the first page of the document. In various embodiments, the system may be configured to only dynamically insert advertisements into particular digital content after a particular number of times that the content is accessed by a user (e.g., the system may only place advertisements in digital content after a user has already viewed the digital content one time or another pre-determined number of times).

Returning to Step 330, the system continues by communicating the requested digital content with the inserted one or more advertisements to the user. The user may be a user that requested to view the digital content, or any other user. In particular embodiments, the system may be configured to display the requested digital content in any suitable manner (e.g., on a display associated with a mobile device, laptop, tablet, etc.).

### Exemplary User Experience

As may be understood from the above description, various embodiments of the system may be used in the context of an on-line content management system that allows users to share digital content with each other and/or that allows users to access digital content from shared and/or public folders. The system may be used to insert (e.g., on a dynamic basis) advertising into the content so that the advertising is communicated along with the digital content when the digital content is accessed by a user.

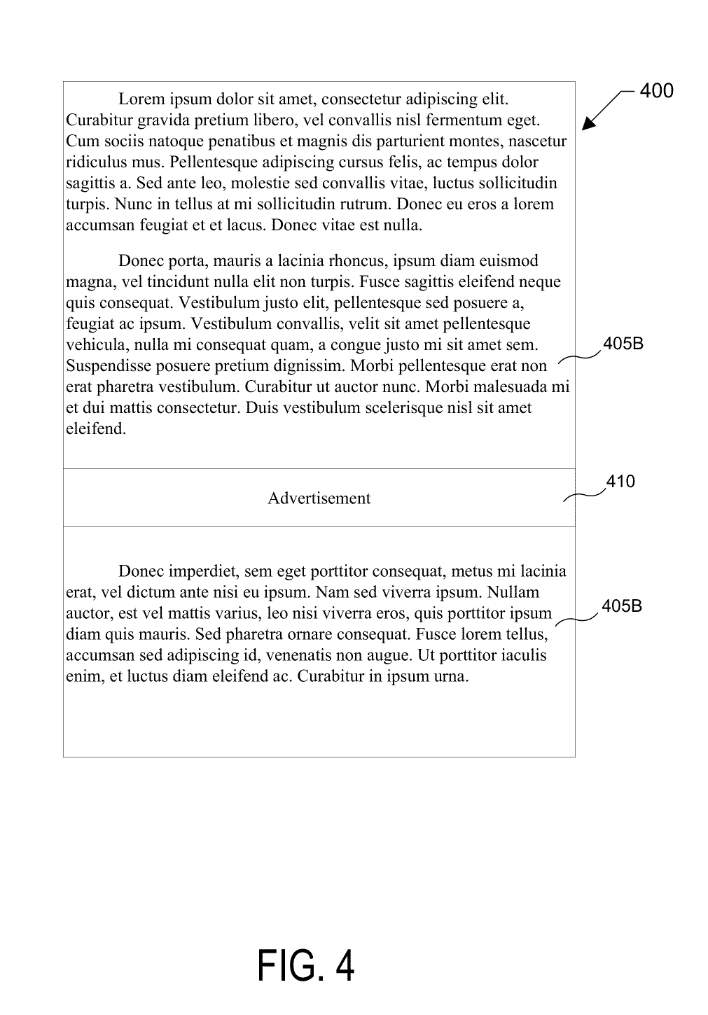

FIG. 4 shows a particular example in which a dynamic advertisement insertion system has inserted advertisement 410 into document 400. In this example, the dynamic advertisement insertion system has adjusted the formatting of document 400 to create space between two paragraphs 405A-B in the document so that advertisement 410 can be placed between the paragraphs 405A-B. The embodiment shown in this figure may represent a document viewed, for example, on a device with a relatively large screen such as a desktop computer, laptop computer, tablet computer, etc.

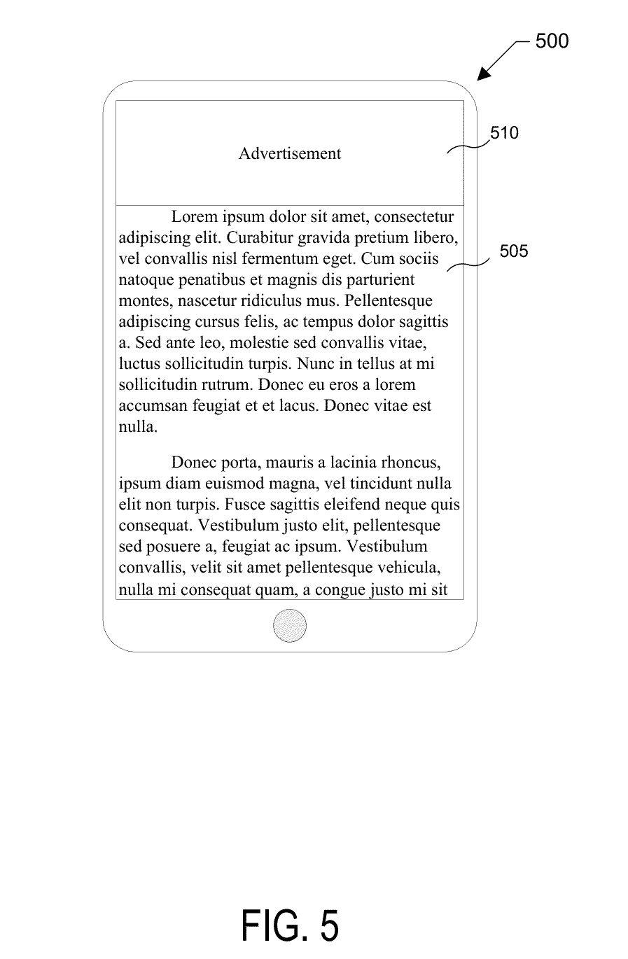

FIG. 5 shows the document from FIG. 4 as shown when accessed from a device with a smaller screen such as mobile device 500 (e.g., a smart phone, etc.). As may be understood from this figure, the dynamic advertisement insertion system has adjusted the formatting of the document by pushing content 505 down within the document to create space near an upper portion of the document in which to display advertisement 510.

### Other Aspects of the System

In various embodiments, they system may be configured to receive owner advertisement preferences for a particular piece of digital content. Owner advertisement preferences may include, for example, limitations on: (1) the size of advertisements that the system may insert into the particular piece of digital content; (2) the types or content of advertisements that may be added to the digital content (e.g., no advertisements for cigarettes, alcohol, or sexually themed materials); (3) which particular portions of the digital content may be adjusted to insert advertisements (e.g., pre-determined portions of a particular text document may not be modified or reformatted to include advertising), or any other aspect of the advertising or content-accessing experience that an owner of digital content may wish to place. The owner of digital content may include, for example, the person that created the digital content.

The gathering and use of data from various sources may improve the quality of targeted advertising. In some instances, the data may include personal information, which could enable more controlled and/or limited delivery of advertising content. Nonetheless, any collection, analysis, disclosure, transfer, storage, or other use of such personal information should comply with or exceed the best-known privacy and security policies and practices. For example, personal information is preferably only collected for legitimate and reasonable uses and should not shared or sold outside of those legitimate uses. In addition, users may be able to selectively block the use of, or access to, personal information, through hardware and/or software elements.

Although the present disclosure contemplates the use of personal information to implement various embodiments, some embodiments can be implemented without the need for accessing such personal information. For example, content can be selected and delivered to users by inferring preferences based on non-personal information data or a bare minimum amount of personal information.

### Conclusion

Having the benefit of the teachings presented in the foregoing descriptions and associated drawings, one of skill in the art will recognize many modifications and other embodiments of the invention. In light of the above, it is to be understood that the invention is not to be limited to the specific embodiments disclosed and that modifications and other embodiments are intended to be included within the scope of the appended claims. Although specific terms are employed herein, they are used in a generic and descriptive sense only and not for the purposes of limitation.

We claim:

1. A computer-implemented method for dynamically inserting advertisements into digital content, the method comprising:
receiving, by a processor, from a user, a request to access digital content;
in response to receiving the request, adjusting, by a processor, a formatting of the requested digital content to create at least one advertising space;
inserting, by a processor, at least one advertisement into the at least one advertising space to create a modified piece of digital content; and
communicating, by a processor, the modified piece of digital content to the user.

2. The computer-implemented method of claim 1, wherein:
the digital content comprises a document comprising text having at least one font size, the text being in a particular position within the document; and
adjusting the formatting of the requested digital content comprises adjusting the position of the text within the document.

3. The computer-implemented method of claim 2, wherein adjusting the formatting of the requested digital content comprises adjusting the at least one font size of the text.

4. The computer-implemented method of claim 1, wherein adjusting the formatting of the requested digital content is done based on a type of device on which the requested digital content with the inserted at least one advertisement is to be displayed to the user.

5. The computer-implemented method of claim 1, wherein:
the requested digital content is digital content shared by a plurality of users within an online content management system; and
the method further comprises determining which of a plurality of advertisements to insert into the at least one advertising space based on information associated with each of at least two of the plurality of users.

6. The computer-implemented method of claim 5, wherein the content management system is a synchronized, cloud-based content management system.

7. The computer-implemented method of claim 1, further comprising determining which of a plurality of advertisements to insert into the at least one advertising space based on information associated with the requested digital content.

8. The computer-implemented method of claim 7, wherein the information associated with the requested digital content is selected from a group consisting of:
a file type of the requested digital content;
content of the requested digital content; and
metadata associated with the requested digital content.

9. The computer-implemented method of claim 1, wherein:
the request is a first request;
the user is a first user;
the at least one advertising space is a first at least one advertising space;
the at least one advertisement is a first at least one advertisement; and
the method further comprises:
receiving, by a processor, a second request to access the digital content;
in response to receiving the second request, adjusting the formatting of the requested digital content, by a processor, to create a second at least one advertising space, wherein the second at least one advertising space is different from the first at least one advertising space;
inserting, by a processor, a second at least one advertisement into the second at least one advertising space; and
displaying, by a processor, the requested digital content with the inserted second at least one advertisement to a second user.

10. The computer-implemented method of claim 9, wherein the first user is the second user.

11. The computer-implemented method of claim 9, wherein the first at least one advertisement is the second at least one advertisement.

12. The computer-implemented method of claim 1, further comprising:
determining a number of times that the requested digital content is displayed along with inserted advertising content; and
compensating an owner of the digital content for the use of the digital content based on the determined number of times.

13. The computer-implemented method of claim 1, further comprising allowing an owner of the digital content to place one or more restrictions on the way that the format of the digital content may be adjusted to create the advertising space.

14. A computer system comprising at least one processor, wherein the computer system is configured for:
receiving a request to access digital content;
in response to receiving the request, dynamically inserting at least one advertisement into the digital content; and
communicating the digital content with the inserted at least one advertisement to a user.

15. The computer system of claim 14, wherein dynamically inserting at least one advertisement into the digital content includes overlaying the at least one advertisement over the digital content.

16. The computer system of claim 15, wherein the overlain at least one advertisement is partially transparent.

17. The computer system of claim 14, wherein dynamically inserting at least one advertisement into the digital content comprises adjusting an arrangement of the digital content to create space in which to insert the at least one advertisement.

18. The computer system of claim 14, wherein the computer system is a synchronized content management system.

19. A computer-readable medium storing computer-executable instructions for:
receiving, from a first user of a synced content management system, a request to access particular digital image content;
in response to receiving the request, selecting a digital advertisement to overlay over the particular digital image content;
modifying the digital image content so that the digital advertisement is overlaid over the digital image content; and
communicating the modified digital image content with the overlaid digital advertisement to the first user.

20. The computer-readable medium of claim 20, wherein the digital image content is stored within a folder within the synched content management system that is shared between a plurality of user accounts within the synched content management system.

21. The computer-readable medium of claim 20, wherein the computer-readable medium stores computer-executable instructions for determining which of a plurality of advertisements to overlay over the digital image content based on information associated with at least two of the plurality of user accounts.

22. The computer-readable medium of claim 19, wherein:
the request is a first request;
the advertisement is a first advertisement; and
the computer-readable medium stores computer-executable instructions for:
in response to receiving a second request, selecting a second advertisement to overlay over the particular digital image content;
modifying the digital image content so that the second advertisement is overlaid over the digital image content; and
communicating the modified requested digital content including the overlaid second advertisement to a second user.
